(19) United States
(12) Patent Application Publication
(10) Pub. No.: US 2022/0277140 A1
(43) Pub. Date: Sep. 1, 2022

(54) ARTIFICIAL INTELLIGENCE-BASED LEGAL DOCUMENT ANALYSIS SYSTEM AND METHOD

(71) Applicant: INTELLICON LAB INC., Seoul (KR)

(72) Inventor: Young-Yik RHIM, Seoul (KR)

(73) Assignee: INTELLICON LAB INC., Seoul (KR)

(21) Appl. No.: 17/637,641

(22) PCT Filed: Oct. 11, 2019
(86) PCT No.: PCT/KR2019/013325

§ 371 Date: Feb. 23, 2022

(30) Foreign Application Priority Data
Aug. 23, 2019 (KR) 10-2019-0103457

(51) Int. Cl. G06F 40/253; G06V 30/42; G06N 5/04; G06V 30/30

(52) U.S. Cl. CPC G06F 40/253; G06V 30/42; G06N 5/045; G06V 30/30

(57) ABSTRACT

Disclosed are an artificial intelligence-based legal document analysis system and method. The present invention can provide relevant laws and detailed explanation by analyzing the legal risk in a legal document having a structure such as legal clauses, terms and conditions and contracts by automatically comprehending the meaning by means of an artificial intelligence technology, and perceiving omissions and erroneous risk elements in the contract.

### TECHNICAL FIELD

The present invention relates to artificial intelligence-based legal document analysis system and method, and more particularly, to a system and a method for analyzing an artificial intelligence-based legal document, which can analyze legal risks and provide explanations of meanings by automatically reading legal documents having structures, such as legal clauses, terms and conditions, and contracts or agreements using artificial intelligence technology, such as natural language processing, convolutional neural net (CNN), long short term memory (LSTM), and the likes.

### BACKGROUND ART

In general, legal documents exist in various forms, such as laws, precedents, interpretations, clauses, written contracts or agreements, and the likes.

In particular, the written contracts or agreements are legal documents to which general people are easily accessible, and are subdivided into real estate contracts, investment agreements, sale-and-purchase agreements, confidentiality agreements, employment agreements, and the likes according to subject matters and relevant laws.

Such contracts or agreements are general documents written in various relationships formed in daily life, but have legal force.

That is, a contract or an agreement includes legal elements and items, and is utilized as a legal basis that can be consulted when a contract-related problem occurs in the future.

Therefore, when a contract or an agreement is written, it is necessary to follow a predetermined guideline and to include essential contents.

However, since the parties who make a contract or an agreement generally have just a common-sense level of legal knowledge, essential contents may be omitted when a contract or an agreement is written or items unfavorable to one party unilaterally may be written.

So, in many cases, the parties take counsel or get a review from a legal expert or get help from surroundings.

Even though there is a guideline of a legal document, it is impossible to accurately fit the guideline, and even a legal expert cannot cover all items used for various contracts or agreements.

Especially, even if it is possible to find out wrong items, it is not easy for even an expert to identify missing items.

In other words, when a contract or an agreement is reviewed, it takes a great deal of time and manpower to adjust important contents of the contract or the agreement and to recognize and amend potential legal problems.

Therefore, a system and a method for analyzing an artificial intelligence-based legal document, which can analyze legal risks and provide explanations of meanings by automatically reading legal documents having structures, such as legal clauses, terms and conditions, and contracts or agreements using artificial intelligence technology, such as natural language processing, convolutional neural net (CNN), long short-term memory (LSTM), and the likes are required.

### DISCLOSURE

### Technical Problem

Accordingly, the present invention has been made in an effort to solve the above-mentioned problems occurring in the prior arts, and it is an object of the present invention to provide artificial intelligence-based legal document analysis system and method, which can analyze legal risks and provide explanations of meanings by automatically reading legal documents having structures, such as legal clauses, terms and conditions, and contracts or agreements using artificial intelligence technology, such as natural language processing, convolutional neural net (CNN), long short term memory (LSTM), and the likes.

### Technical Solution

To achieve the above objects, the present invention provides an artificial intelligence-based legal document analysis system, which when a target legal document is inputted into a legal document analysis server, analyzes the inputted legal document in a sentence unit to classify the analyzed sentence into a predetermined class and at least one label, compares the analyzed sentence and the classified class with pre-stored reference information to detect whether there is at least one among a missing sentence, a risk error element, and a missing class.

Moreover, the artificial intelligence-based legal document analysis system according to an embodiment of the present invention displays a writing sample including the missing sentence and class when the missing sentence is detected, and generates and displays interpretation information including the risk error element when a risk error element is detected.

Moreover, the legal document analysis server includes: a document information analyzing unit which analyzes the inputted legal document in a sentence unit to classify the analyzed sentence into a predetermined class and at least one label; an analysis inference unit which compares the analyzed sentence and the classified class with pre-stored reference information to detect whether there is a missing sentence, a risk error element, and a missing class, generates and displays the missing sentence and class and a writing sample when an omission is detected, and generates and displays interpretation information including the risk error element when a risk error element is detected; and a database connected to the document information analyzing unit and the analysis inference unit to store information.

Furthermore, the document information analyzing unit (210) analyzes and outputs the contents included in the legal document through pre-processing, such as correction of “A” and “B”, correction of blanks, English/Korean conversion, conversion of synonyms, etc., masking for time, date, phone number, etc., and analysis of morphemes in sentences.

Additionally, the analysis inference unit extracts metadata displaying important information from the analyzed sentence and class, and compares the extracted metadata with a preset risk error element to detect whether there is a risk error element.

In addition, the analysis inference unit includes: an omission detecting unit which compares the analyzed sentence and the classified class with pre-stored reference information to detect whether there is a missing sentence or class; a risk detecting unit which compares the metadata extracted from the analyzed sentence and class with a preset risk error element to detect there is any risk element; a meta information extracting unit which extracts metadata displaying important information from the analyzed sentence and class; and an explanation generating unit outputting the analysis result information detected by the omission detecting unit and the risk detecting unit according to a preset format.

Moreover, the explanation generating unit displays the analysis result information as at least one of visualization information and text information.

Furthermore, the explanation generating unit extracts and displays law information corresponding to the missing information and the risk error element.

Additionally, the legal document to be analyzed is any one among an electronic document of a predetermined format, an electronic document transmitted from a user terminal connected through a network, and an electronic document converted from an optical means including any one of a camera and an OCR.

In another aspect of the present invention, there is provided an artificial intelligence-based legal document analysis method including the steps of: a) inputting a type of a legal document to be analyzed, preset basic information, and a legal document to a legal document analysis server; b) analyzing the inputted legal document in a sentence unit by the legal document analysis server to classify the analyzed sentence into a predetermined class and at least one label, and comparing the analyzed sentence and the classified class with pre-stored reference information to detect whether there is at least one among a missing sentence, a risk error element, and a missing class; and c) generating and displaying a writing sample including the missing sentence and class or generating and displaying interpretation information including the risk error element by the legal document analysis server when at least one among the missing sentence and the risk error element is detected.

Additionally, the step b) further includes the steps of: extracting metadata displaying important information from the sentence and the class by the legal document analysis server; and comparing the extracted metadata with a preset risk error element to detect whether there is any risk error element.

In addition, the risk error element is a specific class that an arbitrary sentence is preset and is determined according to whether a specific word is included in the sentence.

### Advantageous Effects

The present invention can provide artificial intelligence-based legal document analysis system and method, which can analyze legal risks and provide explanations of meanings by automatically reading legal documents having structures, such as legal clauses, terms and conditions, and contracts or agreements using artificial intelligence technology, such as natural language processing, convolutional neural net (CNN), long short-term memory (LSTM), and the likes.

Moreover, the present invention can analyze a previously written contract or agreement, and previously search for various problems that may occur during a contract writing process and provide the same to a user.

Furthermore, the present invention can serve as a contract review helper who can review a contract quickly and accurately like a legal expert.

In addition, the present invention can be a guideline to which a general person who has insufficient legal knowledge can refer when writing a contract.

Additionally, the present invention can reduce the time taken for writing and reviewing a contract, and can prevent a legal dispute, which may occur due to a missing item or a clause beneficial to a specific party.

### DESCRIPTION OF DRAWINGS

FIG. 1 is a block diagram illustrating an artificial intelligence-based legal document analysis system according to an embodiment of the present invention.

FIG. 2 is a block diagram illustrating a configuration of a legal document analysis server of the artificial intelligence-based legal document analysis system of FIG. 1.

FIG. 3 is a block diagram illustrating a configuration of a document information analyzing unit of the artificial intelligence-based legal document analysis system of FIG. 2.

FIG. 4 is a block diagram illustrating a document information extracting unit of the document information analyzing unit according to the embodiment of FIG. 3.

FIG. 5 illustrates a document information extracting unit classifier of FIG. 4.

FIG. 6 is a block diagram illustrating a configuration of a semantic retrieval unit of the document information analyzing unit of FIG. 3.

FIG. 7 is a block diagram illustrating a configuration of an analysis inference unit of the legal document analysis server of FIG. 2.

FIG. 8 illustrates an analysis and inference metadata extraction model according to FIG. 7.

FIG. 9 is a flow chart illustrating an analysis process using the artificial intelligence-based legal document analysis system according to an embodiment of the present invention.

FIG. 10 illustrates a contract selecting process of the analysis process using the artificial intelligence-based legal document analysis system according to the embodiment of FIG. 7.

FIG. 11 illustrates a basic information input process of the analysis process using the artificial intelligence-based legal document analysis system according to the embodiment of FIG. 7.

FIG. 12 illustrates a contract input process of the analysis process using the artificial intelligence-based legal document analysis system according to the embodiment of FIG. 7.

FIG. 13 is an example showing an analysis result of the analysis process using the artificial intelligence-based legal document analysis system according to the embodiment of FIG. 7.

FIG. 14 is another example showing an analysis result of the analysis process using the artificial intelligence-based legal document analysis system according to the embodiment of FIG. 7.

FIG. 15 is a further example showing an analysis result of the analysis process using the artificial intelligence-based legal document analysis system according to the embodiment of FIG. 7.

FIG. 16 is a still further example showing an analysis result of the analysis process using the artificial intelligence-based legal document analysis system according to the embodiment of FIG. 7.

### MODE FOR INVENTION

Hereinafter, artificial intelligence-based legal document analysis system and method according to preferred embodiments of the present invention will be described in detail with reference to the accompanying drawings.

Also, when a part “includes” or “comprises” an element, unless there is a particular description contrary thereto, the part can further include other elements, not excluding the other elements.

Moreover, terms such as “unit” and “module” indicate a unit for processing at least one function or operation, wherein the unit and the block may be embodied as hardware or software or embodied by combining hardware and software.

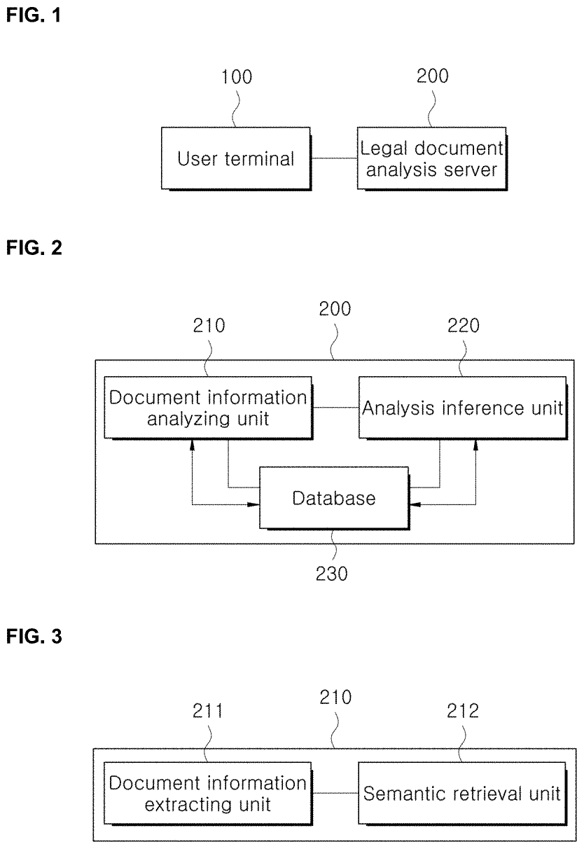

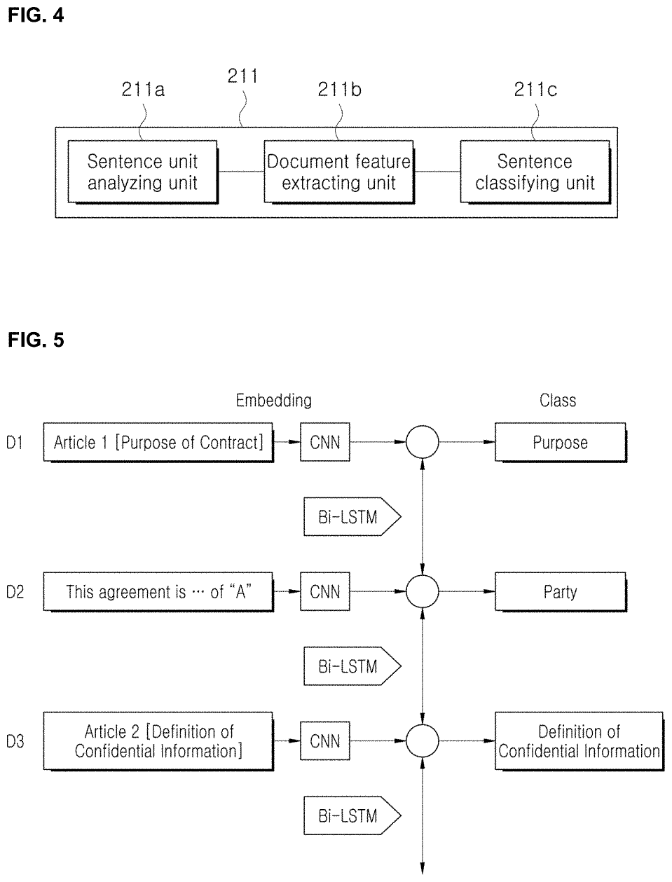

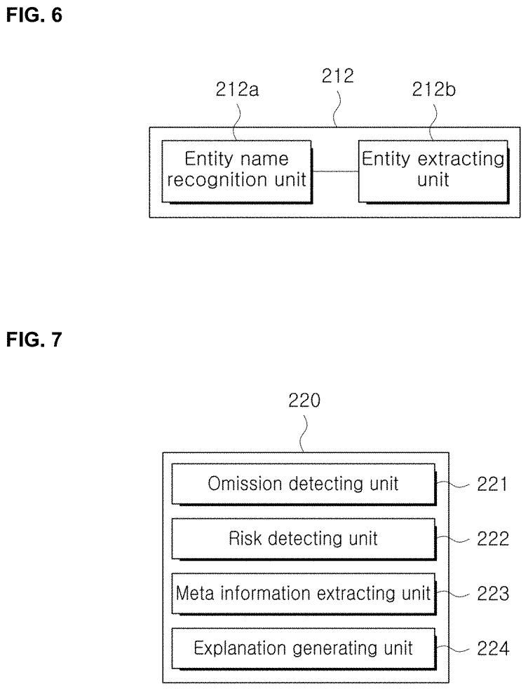

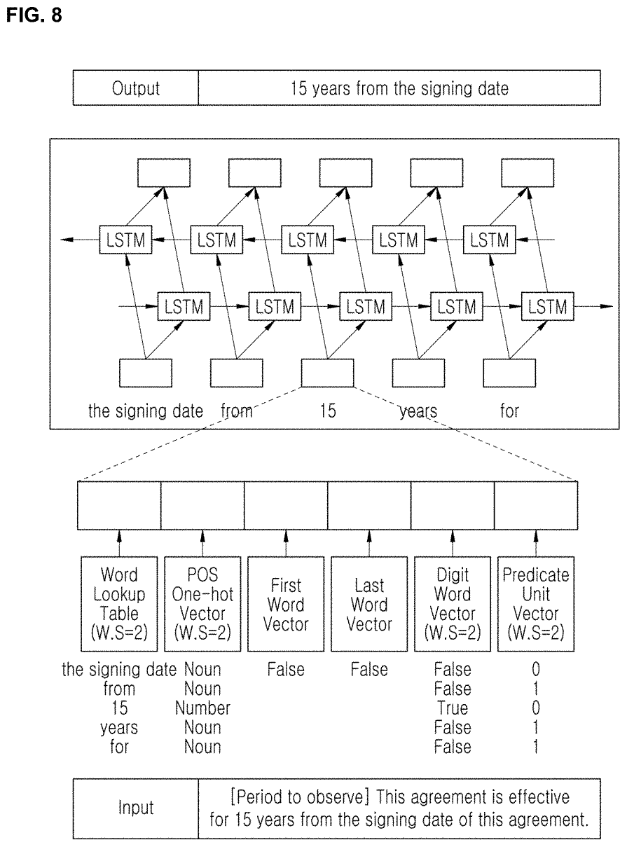

FIG. 1 is a block diagram illustrating an artificial intelligence-based legal document analysis system according to an embodiment of the present invention, FIG. 2 is a block diagram illustrating a configuration of a legal document analysis server of the artificial intelligence-based legal document analysis system of FIG. 1, FIG. 3 is a block diagram illustrating a configuration of a document information analyzing unit of the artificial intelligence-based legal document analysis system of FIG. 2, FIG. 4 is a block diagram illustrating a document information extracting unit of the document information analyzing unit according to the embodiment of FIG. 3, FIG. 5 illustrates a document information extracting unit classifier of FIG. 4, FIG. 6 is a block diagram illustrating a configuration of a semantic retrieval unit of the document information analyzing unit of FIG. 3, FIG. 7 is a block diagram illustrating a configuration of an analysis inference unit of the legal document analysis server of FIG. 2, and FIG. 8 illustrates an analysis and inference metadata extraction model according to FIG. 7.

As illustrated in FIGS. 1 to 8, the artificial intelligence-based legal document analysis system according to the present invention includes a user terminal 100 and a legal document analysis server 200.

The user terminal 100 is connected to the legal document analysis server 200 through a wired or wireless network to provide an analysis target legal document, and may be a desktop PC, a notebook PC, a tablet PC, a smartphone, or a mobile terminal capable of installing any application program.

In addition, the legal document to be analyzed may be an electronic document file of a predetermined format, for instance, *.docx, *.txt, or the like, which is provided from the user terminal 100, or an electronic document file obtained from an optical means including any one of a camera and an OCR to be converted.

Meanwhile, in the present embodiment, the legal document to be analyzed is described with a contract for convenience of explanation, but is not limited thereto, and includes all documents having legal information.

The legal document analysis server 200 includes a document information analyzing unit 210, an analysis inference unit 220, and a database 230 to analyze legal risks and provide explanations of meanings by automatically reading legal documents having structures, such as legal clauses, terms and conditions, and contracts or agreements.

The document information analyzing unit 210 analyzes an inputted legal document in a sentence unit, classifies the analyzed sentence into a predetermined class and at least one label, and includes a document information extracting unit 211 and a semantic retrieval unit 212.

Moreover, the document information analyzing unit 210 analyzes and outputs the contents included in the legal document through, for example, 1) a pre-processing process, such as correction of “A” and “B”, correction of blanks, English/Korean conversion, conversion of synonyms, etc., 2) masking for time, date, phone number, etc., and 3) analysis of morphemes in sentences.

Furthermore, the document information analyzing unit 210 does not classify one sentence into one label but can classify the sentence into multiple labels.

The labels can be embodied according to types of contracts or agreements. In the case of an employment agreement, the labels can be classified into ‘agreement title’, ‘agreement parties’, ‘agreement date’, ‘wage’, ‘purpose’, ‘duration’, ‘indication of parties’, ‘contents of business’, ‘working hours’, ‘delivery of employment agreement’, ‘duties to observe’, ‘firing/cancellation’, ‘role, rights, and obligations’, ‘day-off’, ‘compensation for damages’, ‘place of work’, ‘severance pay’, ‘bonus’, and the likes.

The document information extracting unit 211 receives attributes of the inputted legal document to be analyzed from the document information analyzing unit 210, analyzes the attributes of the inputted legal document in the sentence unit, in the ‘article’ unit, or in the ‘paragraph’ unit. The document information extracting unit 211 includes a sentence unit analyzing unit 211a, a document feature extracting unit 211b, and a sentence classifying unit 211c.

The classes may be basic elements for a contract or an agreement, such as, a purpose clause, an applicable law clause, a definition of terms clause, and the like. These classes can be set differently depending on the types of contracts or agreements.

The sentence unit analyzing unit 211a analyzes and outputs the inputted legal document in the sentence unit, in the ‘article’ unit, or in the ‘paragraph’ unit.

Moreover, the sentence unit analyzing unit 211a may analyze and output words in a sentence by morpheme units.

The document feature extracting unit 211b is configured to perform embedding. The document feature extracting unit 211b can embed words, sentences, or ‘articles’ or ‘paragraphs’ using techniques of doc2vec, word2vec, and latent semantic analysis (LSA), convert them into vectors, and extract document features through a large volume contract document group using the machine learning-based document feature generation technology.

The sentence classifying unit 211c classifies classes of sentences forming a contract by organically utilizing map learning, data purified by an expert, and the likes using the machine learning-based document classification technology.

The class includes, for example, a purpose clause, an applicable law clause, a definition of terms clause on the contract or agreement.

Moreover, a plurality of the classes may be assigned to each of the sentences.

For instance, when one sentence includes both of information of parties and the purpose of the agreement, the party class and the purpose class can be assigned doubly.

In more detail, the sentence classifying unit 211c classifies classes of a sentence, an ‘article’, and a ‘paragraph’. That is, the sentence classifying unit 211c classifies classes of a sentence, an ‘article’, and a ‘paragraph’ on the basis of a support vector machine (SVM), a convolutional neural network (CNN), or a CNN long short-term memory (CNN-LSTM).

In addition, as illustrated in FIG. 5, the classifier of the document information extracting unit includes, based on the CNN-LSTM, a convolutional neural network (CNN) for extracting one or more sentences, which have a set of words (morphemes), and features from the sentences, a Bi-LSTM reflecting an association between the sentences, and classes classified by the CNN-LSTM.

The semantic retrieval unit 212 extracts an object, and includes an entity name recognition unit 212a and an object extracting unit 212b.

The entity name recognition unit 212a recognizes an entity name corresponding to each word or phrase by using a conditional random field (CRF) and an LSTM technique to reflect the contextual meaning of the semantic element.

The object extracting unit 212b may extract the recognized entity name and include a metadata extraction process to be described below.

The entity name is classified into various labels representing legal semantic elements, which are essential to legal documents, for example, agreement title, agreement parties, agreement date, wage, purpose, duration, and the like.

The entity name includes words related to, for example, time, place, name, and the like.

For example, the object extracting unit can extract an30 million won.

TABLE 1

| Sentence | Object | Entity Name |
|---|---|---|
| 1. ‘B’ receives the annual salary of | Thirty million won | Amount of money: |
| thirty million won in twelve monthly | | Annual salary |
| installments to be deposited into a | | |
| bank account of ‘B’ on the 22^{nd} of | | |
| every month according to the | | |
| provisions of the annual salary | | |
| system for office workers by ‘A’. | | |

The analysis inference unit 220 includes an omission detecting unit 221, a risk detecting unit 222, a meta information extracting unit 223, and an explanation generating unit 224. The omission detecting unit 221 compares the sentence analyzed by the document information analyzing unit 210 and the classified class with pre-stored reference information to detect whether there is any missing sentence or class, and generates and displays the missing sentence and class and a writing sample if an omission is detected. That is, the omission detecting unit 221 compares the analyzed sentence and the classified class with pre-stored reference information and detects whether there are any missing sentence and class or not.

In other words, when contents existing in a contract are classified, the omission detecting unit 221 compares the contents to be essentially included in a legal document, for example, a contract, with the reference information to detect what is missing.

Additionally, detecting an omission, the omission detecting unit 221 requests to display a writing sample including the missing sentence and class to the explanation generating unit 224.

That is, if any content has been omitted, the omission detecting unit 221 guides a user to easily write the omitted contents through the writing sample.

The risk detecting unit 222 compares metadata extracted from the sentence and the class with predetermined risk error elements to detect whether there is any risk element.

That is, once each sentence is classified, the class of the corresponding sentence can be predicted. In this instance, the corresponding sentence and the predicted class form a pair, and the risk detecting unit 222 checks whether a risk error occurs.

In order to check whether a risk error occurs, the risk detecting unit 222 checks and determines whether any sentence is a predetermined specific class and a specific word is included in the sentence.

For instance, if the classified class is ‘compensation for damages’ and any one of words, such as ‘amount’, ‘payment’, and ‘penalty’ is included in the classified sentence, the risk detecting unit 222 determines it as a risk element and asks the explanation generating unit 224 to generate a relevant explanation.

Meanwhile, if the sentence is classified into a class of ‘compensation for damages’ and any one of words, such as ‘criminal’, ‘punishment’, and the like, is included in the sentence, it is not a risk error, but the risk detecting unit can ask the explanation generating unit 224 to generate a relevant explanation.

The meta information extracting unit 223 extracts metadata from the sentence and the class to indicate important information, generates learning data on the basis of metadata information in a predefined sentence, and shows the words in the sentence in the unit of morphemes so that attributes of the words are tagged.

The metadata extraction model is a BiLSTM-CRF model, and uses the BiLSTM-CRF method, which is recently used to recognize entity names in the English-speaking world and in Korea, among the existing deep learning models.

The BiLSTM-CRF method is an advanced model that makes a user to learn well with long-term dependence through an LSTM model by solving a problem of information loss which may be generated in the existing RNN model.

Moreover, a bidirectional LSTM can receive word columns inputted bidirectionally, obtain both of forward information and backward information at each position, and tag whether attributes of each word exist on a CRF output layer based on the information.

Meanwhile, in this embodiment, the metadata extraction model using the BiLSTM-CRF method is described, but the present invention is not limited thereto. It is obvious to those skilled in the art that the metadata extraction model can be varied.

Table 2 shows an example to extract metadata.

TABLE 2

| Class | Sentence | Extraction information |
|---|---|---|
| Wage | 1. ‘B’ receives the annual salary of thirty | 30 million won |
| | million won in twelve monthly installments to | |
| | be deposited into a bank account of ‘B’ on | |
| | the 22^{nd} of every month according to the | |
| | provisions of the annual salary system for | |
| | office workers by ‘A’. | |
| Bonus | Bonus: 3.5 million won | 3.5 million won |
| Working hours | ‘B’ shall work from 9 am to 18 pm every day, | From 9 am to 18 pm |
| | and shall take charge of various works | |
| | necessary for management | |
| Contract date | **. **. 2019 | **. **. 2019 |
| Duration | The duration of contract of ‘B’ is one year | From **. **. 2019 to **. |
| | from **. **. 2019 to **. **. 2020. | **. 2020, for one year |
| Compensation | The amount of compensation for damages | 200% of the amount |
| for damages | shall be an amount corresponding to 200% | spent |
| | of the amount spent in order to fulfill this | |
| | contract. | |
| Conflict solution | If there is a conflict between both parties in | To solve by mutual |
| & jurisdiction | connection with this contract, it is as a rule | consent between ‘A’ and |
| | to solve the conflict by mutual consent | ‘B’ |
| | between ‘A’ and ‘B’. | |

The explanation generating unit 224 generates and outputs explanation information on the missing contents according to a preset format on the basis of the analysis result information detected by the omission detecting unit 221. That is, the explanation generating unit 224 can generate and output a writing sample as shown in Table 3, for instance, if any missing content is detected in the ‘period to observe’.

TABLE 3
Writing sample

“Period to observe” is a confidentiality period. A period that the parties shall keep
confidentiality even after termination of the contract must be written. Writing sample:
Article ∘ (Duration) This agreement is effective for five years from the signing date of this
agreement. But, if the parties exchange confidential information by business connections
before the signing date of this agreement, it shall be retroactively applied as the first
commencement date of the business connections.

In addition, the explanation generating unit 224 can generate and output explanation information on the detected risk error elements on the basis of the analysis result detected by the risk detecting unit 222 as shown in Table 4.

TABLE 4
Explanation

“Compensation for damages”: The provisions of criminal punishment must be inserted for
strict protection of confidential information. So, a sentence, “. . . can apply for criminal
punishment”, is inserted.

Moreover, the explanation generating unit 224 displays analysis result information using text information and visualization information, such as graph information, scheme information, etc. Furthermore, the explanation generating unit 224 extracts and displays law information corresponding to the omission information and the risk error elements.

The database 230 is connected to all information of the above description and stores the results.

The method for analyzing a legal document according to an embodiment of the present invention will be described.

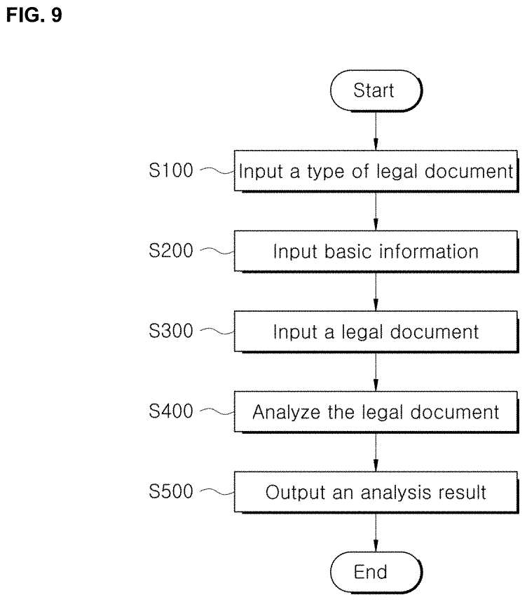

FIG. 9 is a flow chart illustrating an analysis process using the artificial intelligence-based legal document analysis system according to an embodiment of the present invention.

Referring to FIGS. 1 and 9, the legal document analysis server 200 receives a type of a legal document to be analyzed, preset basic information, and a legal document (S100, S200, S300).

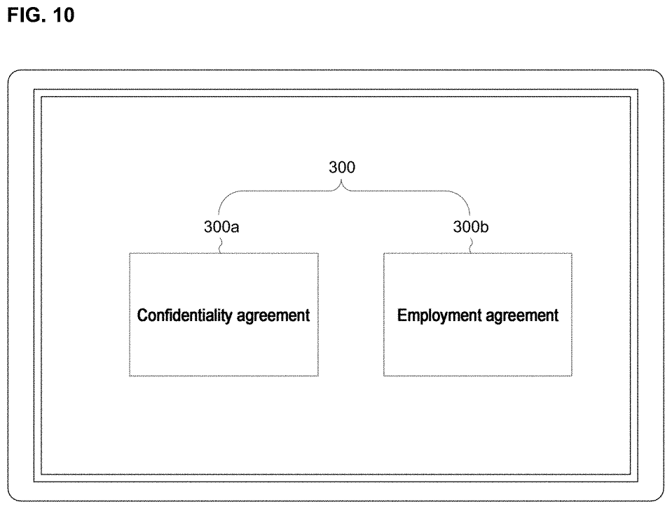

In the step (S100), as illustrated in FIG. 10, when a confidentiality agreement screen 300a and an employment agreement screen 300b are outputted through a legal document selection screen 300, a user can input a type of the legal document to be analyzed.

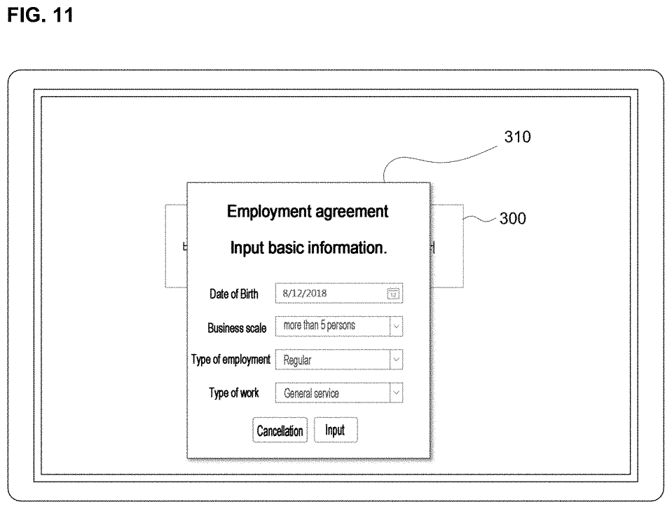

Furthermore, as illustrated in FIG. 11, in the step (S200), the user inputs information of relevant parties of the legal document through a basic information input screen 310.

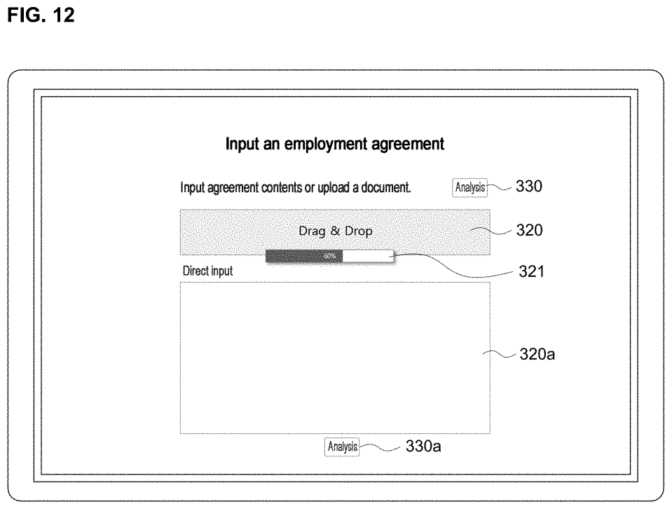

Additionally, as illustrated in FIG. 12, in the step (S300), the user inputs an electronic document file for the legal document through a legal document input screen 320 by a drag-and-drop function or through a direct input window 320a, and then, an upload state can be displayed on a display window 321.

When the upload of the legal document is over and an operation signal is inputted onto analysis request input screens 330 and 330a, the legal document analysis server 200 performs a process of analyzing the inputted analysis target legal document (S400).

In a step (S400), the legal document analysis server 200 analyzes the legal document in a sentence unit and classifies the legal document into a predetermined class and at least one label.

In addition, the legal document analysis server 200 compares the analyzed sentence and the classified class with pre-stored reference information to detect whether there are missing sentence and class.

Moreover, in the step (S400), the legal document analysis server 200 performs a process of extracting metadata indicating important information in the sentence and the class, and compares the extracted metadata with preset risk error elements to detect whether there is any risk error element.

As a result of the analysis of the step (S400), when an omission is detected, the legal document analysis server 200 generates and displays a writing sample including missing sentence and class (S500).

Furthermore, as a result of the analysis of the step (S400), when a risk error element is detected after checking that an arbitrary sentence is a predetermined specific class and whether a specific word is included in the sentence, the legal document analysis server 200 generates and displays interpretation information including the detected risk error element (S500).

On the other hand, the detection of the missing sentence and the detection of the risk error element is performed on the basis of the analyzed sentence in parallel. In the present embodiment, for convenience of explanation, the detection of the missing sentence and the detection of the risk error element are sequentially performed, but the present invention is not limited thereto, the detection of the missing sentence may be performed after the detection of the risk error element.

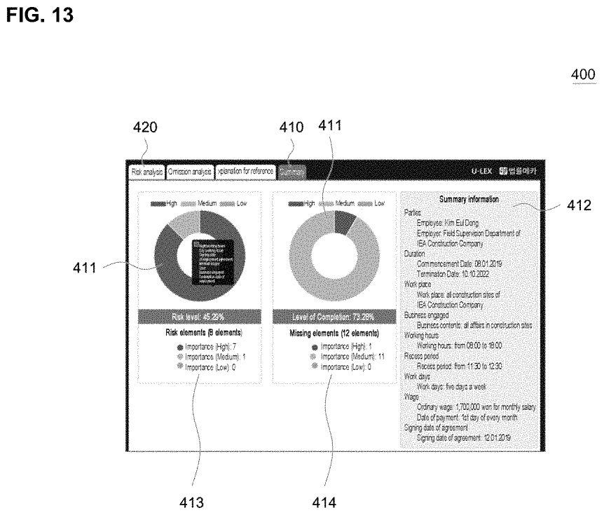

FIG. 13 shows an analysis result screen 400. The analysis result screen 400 includes a visualization display screen 411 for displaying the analysis result information into graph information, scheme information, or the like, and a summary screen 410 having text display screens 412, 413, and 414 for displaying the analysis result information into texts.

That is, the summary screen 410 is divided into the text display screen 412 for displaying summary information of the legal document, the text display screen 413 for displaying the number of risk elements and the risk factors in different colors according to importance, and the text display screen 414 for displaying a missing element to classify and display the contents of the legal document.

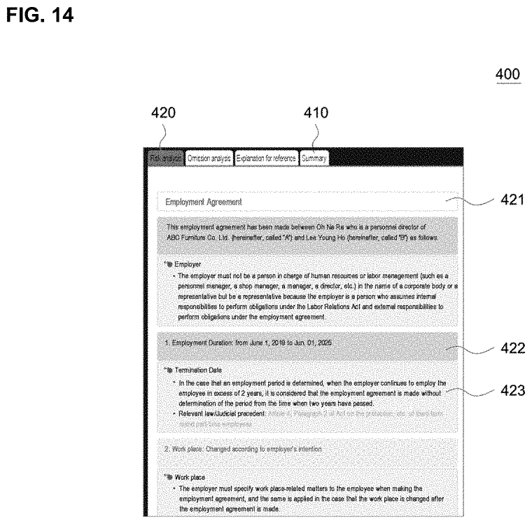

In addition, as illustrated in FIG. 14, the risk analysis screen 420 can display the detailed contents on the text display screen 421.

Additionally, a risk element display screen 422 can be displayed through a highlight effect of different colors according to importance so that information on the risk error element is displayed.

Moreover, law information corresponding to the risk error element is extracted and displayed on a normal display screen 423 so that a user can confirm the law information accurately.

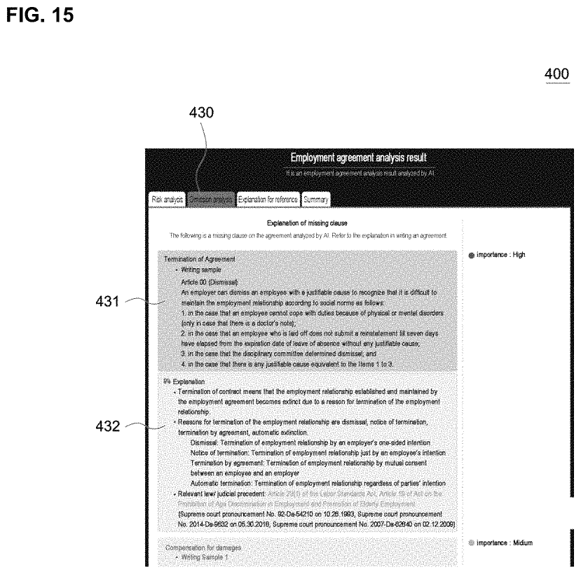

Furthermore, as illustrated in FIG. 15, a missing element display screen 431 of an omission analysis screen 430 displays a missing element through a highlight effect of different colors according to importance.

In addition, the present invention enables a user to supplement a contract or an agreement by displaying additional writing samples on the missing element display screen 431.

Additionally, the law information corresponding to the missing element is extracted and displayed on a law display screen 432 so that a user can confirm the law information accurately.

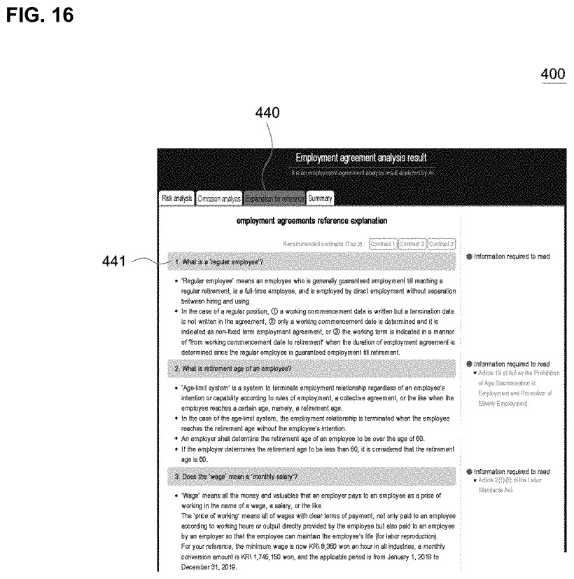

Furthermore, as illustrated in FIG. 16, in a reference explanation screen 440, a text display screen 441 displaying a reference element for essential matters required for writing a document is displayed through a highlight effect of different colors according to importance.

Meanwhile, the display screens shown in FIGS. 10 to 16 are schematically illustrated to describe the embodiments of the present invention, but the present invention is not limited thereto, and it would be obvious to a person skilled in the art that the screens may be varied.

Therefore, legal risk is analyzed by reading a legal document having a structure such as an age clause, a weak tube, and a contract, and the missing and dangerous error elements of the contract are identified to provide related law and detailed explanation.

In addition, the present invention can analyze a previously created contract, previously search various problems that may occur during a contract production process, and provide the searched result to a user, so as to provide a guideline to general people lacking legal knowledge so that the general people can refer to the guideline in writing a contract.

Furthermore, the present invention can reduce the time required for writing and reviewing a contract, and can prevent a legal dispute which can occur due to the occurrence of a missing element or an action advantageous to a specific party.

Although the preferred embodiments of the present invention have been described above, those skilled in the art will appreciate that various modifications and variations can be made in the present invention without departing from the spirit or scope of the invention.

Additionally, the reference numerals described in claims of the present invention are just written for clarity and convenience in explanation, but do not limit the scope of the present invention. Furthermore, thicknesses of lines and sizes of the components illustrated in the drawings may be exaggerated for clarity and convenience in explanation. In addition, the terms described above are defined in consideration of functions of the present invention and may be changed depending on the intention or practice of a user and an operator. Therefore, the terms should be defined based on all contents in the specification.

### EXPLANATION OF REFERENCE NUMERALS

100: User terminal 200: Lega document analysis server

210: Document information analyzing unit

211: Document information extracting unit

211a: Sentence unit analyzing unit

211b: Document feature extracting unit

211c: Sentence classifying unit

212: Semantic retrieval unit

212a: Entity name recognition unit

212b: Entity extracting unit

220: Analysis inference unit

221: Omission detecting unit

222: Risk detecting unit

223: Meta information extracting unit

224: Explanation generating unit

230: Database 300: Legal document selection screen

310: Basic information input screen

320: Legal document input screen

330: Analysis request input screen

400: Analysis result screen 410: Summary screen

411: Visualization display screen

412, 413, 414: Text display screen

420: Risk analysis screen 421: Text display screen

422: Risk element display screen

423: Law display screen 430: Omission analysis screen

431: Missing element display screen

432: Law display screen

440: Reference explanation screen

441: Text display screen

1. An artificial intelligence-based legal document analysis system characterized by, when a target legal document is inputted into a legal document analysis server:
analyzing the inputted legal document in a sentence unit to classify the analyzed sentence into a predetermined class and at least one label;
comparing the analyzed sentence and the classified class with pre-stored reference information to detect whether there is at least one among a missing sentence, a risk error element, and a missing class; and
displaying a writing sample including the missing sentence and class when the missing sentence is detected, and generating and displaying interpretation information including the risk error element when a risk error element is detected.

2. The artificial intelligence-based legal document analysis system according to claim 1, wherein the legal document analysis server comprises:
a document information analyzing unit which analyzes the inputted legal document in a sentence unit to classify the analyzed sentence into a predetermined class and at least one label;
an analysis inference unit which compares the analyzed sentence and the classified class with pre-stored reference information to detect whether there is a missing sentence, a risk error element, and a missing class, generates and displays the missing sentence and class and a writing sample when an omission is detected, and generates and displays interpretation information including the risk error element when a risk error element is detected; and
a database connected to the document information analyzing unit and the analysis inference unit to store information.

3. The artificial intelligence-based legal document analysis system according to claim 2, wherein the document information analyzing unit analyzes and outputs the contents included in the legal document through pre-processing, such as correction of “A” and “B”, correction of blanks, English/Korean conversion, conversion of synonyms, etc., masking for time, date, phone number, etc., and analysis of morphemes in sentences.

4. The artificial intelligence-based legal document analysis system according to claim 2, wherein the analysis inference unit extracts metadata displaying important information from the analyzed sentence and class, and compares the extracted metadata with a preset risk error element to detect whether there is a risk error element.

5. The artificial intelligence-based legal document analysis system according to claim 4, wherein the analysis inference unit comprises:
an omission detecting unit which compares the analyzed sentence and the classified class with pre-stored reference information to detect whether there is a missing sentence or class;
a risk detecting unit which compares the metadata extracted from the analyzed sentence and class with a preset risk error element to detect there is any risk element;
a meta information extracting unit which extracts metadata displaying important information from the analyzed sentence and class; and
an explanation generating unit outputting the analysis result information detected by the omission detecting unit (221) and the risk detecting unit according to a preset format.

6. The artificial intelligence-based legal document analysis system according to claim 5, wherein the explanation generating unit displays the analysis result information as at least one of visualization information and text information.

7. The artificial intelligence-based legal document analysis system according to claim 6, wherein the explanation generating unit extracts and displays law information corresponding to the missing information and the risk error element.

8. The artificial intelligence-based legal document analysis system according to claim 1, wherein the legal document to be analyzed is any one among an electronic document of a predetermined format, an electronic document transmitted from a user terminal connected through a network, and an electronic document converted from an optical means including any one of a camera and an OCR.

9. An artificial intelligence-based legal document analysis method comprising the steps of:
a) inputting a type of a legal document to be analyzed, preset basic information, and a legal document to a legal document analysis server;
b) analyzing the inputted legal document in a sentence unit by the legal document analysis server to classify the analyzed sentence into a predetermined class and at least one label, and comparing the analyzed sentence and the classified class with pre-stored reference information to detect whether there is at least one among a missing sentence, a risk error element, and a missing class; and
c) generating and displaying a writing sample including the missing sentence and class or generating and displaying interpretation information including the risk error element by the legal document analysis server when at least one among the missing sentence and the risk error element is detected.

10. The artificial intelligence-based legal document analysis method according to claim 9, wherein the step b) further comprises the steps of:
extracting metadata displaying important information from the sentence and the class by the legal document analysis server; and
comparing the extracted metadata with a preset risk error element to detect whether there is any risk error element.

11. The artificial intelligence-based legal document analysis method according to claim 10, wherein the risk error element is a specific class that an arbitrary sentence is preset and is determined according to whether a specific word is included in the sentence.
